(19) United States
(12) Patent Application Publication
(10) Pub. No.: US 2026/0211266 A1
(43) Pub. Date: Jul. 23, 2026

(54) Inkjet Colorization and Imaging System for Eyewear Lenses

(71) Applicants: Yen-Ting Wu, Tainan (TW); Tien-Shu Wu, Tainan (TW)

(72) Inventors: Yen-Ting Wu, Tainan (TW); Tien-Shu Wu, Tainan (TW)

(21) Appl. No.: 19/568,723

(22) Filed: Mar. 16, 2026

Related U.S. Application Data
(63) Continuation-in-part of application No. 18/368,537, filed on Sep. 14, 2023, now abandoned.
(60) Provisional application No. 63/407,572, filed on Sep. 16, 2022.

(51) Int. Cl. G02C 7/10; B41F 31/08; B41M 3/00; G02B 1/10; G02C 7/02

(52) U.S. Cl. CPC G02C 7/102; B41F 31/08; B41M 3/003; G02B 1/10; G02C 7/022

(57) ABSTRACT

A colorized lens or photochromic layer on the surface of eyewear is provided using nozzles emitting material to form colors and images or photochromic material upon the exterior surface of the lens. In the colorized mode, a viewing area may be formed within the image to provide a view through a single color layer area or an area of no imaging ink, to eliminate images and lines thereof from the view of a wearer of the lens. predetermined photochromic regions on the lens substrate

### FIELD OF THE INVENTION

This application is a continuation in part application to U.S. patent application Ser. No. 18/368,537 filed on Sep. 14, 2023, which claims priority to U.S. Provisional Patent application Ser. No. 63/407,572 filed on Sep. 16, 2022, which is incorporated herein in its entirety by this reference thereto.

The present device relates to the formation of eyewear lenses, such as those for sunglasses, goggles, and spectacles. More particularly, the system and method herein relate to the formation of color and images or photochromic layers upon such eyewear lenses through the employment of an inkjet or spray nozzle printing for the formation of colorized layers upon the lenses.

### BACKGROUND OF THE INVENTION

The formation of lenses for eyewear, such as eyeglasses, sunglasses, and goggles, frequently includes the positioning of multiple layers of optically correct material where each functions to filter light or reflect light or both filter and reflect light communicated to and through the formed lens. For example and in no way limiting, optically correct layers are engaged to lenses which include a hard coat to help prevent scratching and abrasion, an anti-fog coating to help prevent moisture related fogging, a mirror coating to reflect a portion of light at a particular color or wavelength, and anti-reflective coatings to minimize reflections such as on the side of the lens viewed by the user. Most such coatings are applied using either films that are configured to the purpose or vacuum deposition or immersion. This employment of film and coatings significantly increases the time for forming such lenses, where multiple layers are overlain and also causes a significant increase in the overall cost of lens production due to the significant time required. With regard to photochromic lenses, they are primarily manufactured by embedding light-sensitive organic dyes (such as naphthopyrans or spirooxazines) directly into plastic materials like polycarbonate or resin during lens manufacture. These dyes change shape and darken upon UV exposure. Common manufacturing methods include heat-infusing a photochromic dye to fuse into the top layer of a lens or mixing the dye throughout the lens material during casting.

The foregoing examples of conventional multilayer lens formation and different coatings and layers and the like are intended to be illustrative and not exclusive, and they do not imply any limitations on the lens coating invention described and claimed herein. Various other limitations of the related art are known or will become apparent to those skilled in the art upon a reading and understanding of the specification below and the accompanying drawings.

### SUMMARY OF THE INVENTION

The system and method herein disclosed provides for the formation of colorized layers, reflective layers and/or images and photochromic layers and the like on the exterior surface of lenses employed for eyeglasses, goggles, safety shields, and spectacles and the like. Through the employment of inkjet or pressurized nozzle-deposited inks upon the exterior surface of lenses, a significant reduction in the time required to form colored and reflective layers, and especially photochromic lenses. Further, virtually any image or pattern can be imparted to lenses, thereby allowing for a significant increase in the ability for customization of lenses.

The system herein in operation to form colorized lenses or images employs a primer layer that is imparted to cover one or both sides of the lens to be employed for eyewear, such as sunglasses or goggles, and the like. The primer layer material, when cured, is substantially optically correct and transparent, wherein the optics of the lens itself are not impacted.

The positioning of this primer layer on the polymeric or glass material forming the eyewear lens is preferred to ensure that the ink composition imparted to the lens to form colorization and images and the like in a colorized layer on the lens, adheres strongly to the underlying substrate of polymeric or glass lens material. While the ink formulation forming the colorized layer may be adjusted to increase adherence, an underlying primer layer is preferred. Without the positioning of the primer layer upon the lens substrate, additionally applied layers such as the colorized layer, hard coatings, anti-fog coatings, mirror coatings, and/or anti-reflective coatings, are subject to peeling and dismounting should the bottom layer of ink peel or dismount from the polymeric or glass lenses.

By the term primer herein is meant a water-based primer material formed primarily of water, EB Glycol Ether, and N-Methyl-2-Pyrrolidone (NMP) with an index of refraction between 1.0 and 2.0, with a current favored material being a material such as CrystalCoat PR-670 having an index of refraction of substantially 1.5 as manufactured by SDC Technologies of Irvine, California. Another preferred primer is CrystalCoat PR-765, formed of water and Ethylene Glycol Mono Butyl Ether, also from SDC Technologies. However, other primers as would be employed by those skilled in the art may be used and are anticipated within the scope of this patent. Any primer layer noted herein may be sprayed upon the lens, but more preferably may be dip-coated or flow-coated upon the lens either under or over an ink layer.

The term ink, as used herein, is intended to include not only any ink adapted to flow through and from an inkjet type nozzle which may include transparent dye or pigment-containing materials, but any flowable substance or composition which can be mixed and configured for application to the primer layer and/or lens substrate surface for forming colors, indicia, symbols, characters or patterns thereon. Further, such inks currently employ preferred solvent type inks with volatile organic compounds (VOCs) and UV curable inks and the like.

Additionally, meant by the term ink where a colorized image or surface is being formed, is a jet ink composition that includes, in addition to a particulate pigment material and a solvent composition, a resin composition. The current preferred resin composition includes an uncured silicone resin, an uncured epoxy resin, and an uncured melamine resin. Upon a thermal cure, the uncured resin composition, a cured resin composition is formed with superior adhesion to substrates such as but not limited to glass substrates, ceramic substrates and metal oxide substrates. Currently, ink from 3MACJET Technology in Taiwan is employed with excellent results.

The colorized layer herein is created using a computer-controlled spray/inkjet process. The formation of the colorized layer is not invasive like the traditional tint process, where the color/ink forming a colorized layer is inset or formed inherent into the lens material. Instead, the colorized layer created, using the system herein, is formed much like a coating which, using conventional methods and materials, will not adhere sufficiently to be sold as a lens product.

To achieve this advanced and enhanced adhesion of the nozzle-deposited colorized layer, good adhesion thereof must occur, or it will have the same defects as conventional attempts of forming colorized layers on lenses, such as peeling during consumer use. The advanced adhesion of this colorized layer, enabling the use of computer-controlled inkjet printers or nozzles, is achieved using a mixture of individual amounts of ink, dye, and specific resin mix using multiple resins.

The use of the formulated ink composition herein, for forming the colorized layer upon lenses, with adherence substantially equal to or superior to that using the above noted conventional method, replaces the need for vacuum deposition and other time-consuming means for forming a colorized layer on the lens.

This formulated ink coating and method thereof, forming the colorized coated layer on the lens, are all predicated upon forming the ink composition best suited to adhere to the substrate intended, which preferably includes the noted primer layer. The ink composition varies depending on this substrate and primer composition and includes, in addition to a particulate ink pigment material such as those from 3MAC company of Taiwan, a solvent composition and a resin composition. This resin composition includes an uncured silicone resin, an uncured epoxy resin, and an uncured melamine resin.

Upon thermal curing of the ink composition, the uncured resin in the ink composition, which defines the colorized layer, forms a cured resin composition with superior adhesion to substrates, such as, for example, and in no way limiting, plastic or polymeric substrates, glass substrates, ceramic substrates, and metal oxide substrates. Thus, it is this ink composition, noted above, which significantly improves the adhesion of the colorized layer formed by the ink composition to thereby match or exceed colorized layers achievable by conventional means, such as vapor deposition and the like, and at a fraction of the time. Further, the ink composition herein can be deposited to the colorized layer using inkjet printers or other computer-controlled nozzles. This allows for an infinite amount of colors, patterns, and other indicia to be easily formed in the colorized layer, thereby allowing for shorter manufacturing time and more importantly a high degree of customization.

As noted, the colorized layer, formed by the cured ink composition mixture, has enhanced adhesion properties, which can be increased using an underlying primer layer. Currently, a primer, which, when cured to form an adhering primer layer on the underlying polymeric or glass lens, which is substantially optically correct, is therefore preferred. For example only and in no way limiting, Crystal Coat PR-670 or Crystal Coat PR-765 from SDC Technologies of Irvine, California, which can be applied by dip or flow coat, or Natron G1 Glass primer from Boston Industrial Solutions are examples of such primer material which may be deposited on lenses as a primer layer. Once cured, this primer material leaves a visually undetectable molecular coating on glass or polymeric or other substrate surface, which has a very low refractive index and is adapted for strong adhesion of inks thereon.

As such, once this primer layer is properly applied to one or both sides of the lens, inks employed for nozzle deposit on the substrate for colorized layers and images and the like, will achieve a strong bond to the lens. Thereafter, subsequent optical layers and coatings, and additional primer coatings that attach to the transparent cured ink layer or layers will also maintain a strong bond to the lens.

Additionally, the method herein can employ inks and other liquid materials which may be operatively disbursed from an inkjet type nozzle and cured to thereby form any or all of the other noted sequentially applied coatings and layers. For example, coatings and layers, which in current conventional manufacturing are applied using film, immersion, and/or vacuum deposition, can be applied using the inkjet technology herein, because the primary layer of such adjacent to the lens substrate has achieved adhesion to the optically correct primer layer.

Particularly preferred, in all modes of the lens printing system herein, is the positioning of a determined viewing area through each lens through which the wearer of the lens will, or most likely will, be viewing. Once this determined viewing area is ascertained, any imaging printed to the lens by the nozzles may be adjusted to include no color or a single color within the substantially circular or oval viewing area.

Currently, a viewing area is ascertained from a pupillary distance of a wearer between two of the lenses. when worn. The approximate alignment of each pupil with the substrata or lens will then have preserved a substantially circular viewing area between 5 mm to 25 mm at least above, and preferably above and below, the center point of a diameter line running through and centered upon the determined pupil position. The horizontal line, currently, is between 15-25 mm in length and centered on the center point, aligning with the pupil position. Currently, as shown herein, the viewing area has a curved perimeter edge surrounding the center point thereof, such that an upper and lower hemispheric area is formed.

The viewing area, thus, will only have a single color or no color therein, so the wearer sees an optically correct view through each eye, with no lines or images or dots or the like, which is aligned with a respective viewing area on each lens. Of course, the other coatings placed on top of the image, such as mirror or colorized coatings, will still have only a single color in the viewing area so that the wearer is not viewing through images.

This viewing area can be ascertained in advance for each lens wearer individually or by an estimate. It can be determined individually by having an optician or the wearer determine the pupillary distance of a wearer and then calculating where the center of each pupil on each lens will be located, once the lenses are in a frame on the head of the wearer. However, such a determined viewing area may also employ a pupillary distance determined to provide a center point for the viewing area for each lens by using an average pupillary distance for adults, which is around 60-64 mm, and using a computer model of the lenses being printed upon, as mounted within frames.

By a viewing area for each lens, thus is meant herein, an area upon the substrate or eyewear lens, surrounding a center point thereof determined to substantially align with a pupil of the wearer of the lens when worn in frames. The viewing area is substantially at least 5 mm above and preferably also below the pupil-aligned center point and may extend sideways along a horizontal center line.

If images are printed within the viewing area, only a single color of ink is positioned within the viewing area from the printing of the images. The center of the perimeter of the viewing area, currently in a preferred range, is from 5 mm to 25 mm above the center point and curving to each side thereof. In an especially preferred mode, the viewing area will extend below the horizontal center line a substantially equal amount as above. Other coatings may be added thereafter so long as they are evenly applied in the viewing area.

As such, the viewing area is an important inclusion in the formation of the lenses herein and forming a viewing area within the printed image or images on each lens is especially preferred. Where artwork is supplied for the image printing on a lens, such will be adjusted to include the determined viewing area on each lens within the artwork.

The system herein, as noted may also be employed to form photochromic lenses, which do not have the photochromic material embedded in or formed into the lens material, but are formed with a layer or coating on the exterior. The Photochromic materials may include dyes, microcapsules, spirooxazines, naphthopyrans, fulgides, or diarylethenes or other photochromic material which may be sprayed in droplets to form a photochromic layer. Lenses herein for such a photochromic layer may include polycarbonate, CR-39, high index plastics, acrylic, or glass.

With regard to the formation of photochromic lenses, by ink or liquid material which is deposited in droplets upon the exterior surface of a lens is meant, any light-sensitive organic dye (such as naphthopyrans or spirooxazines) or similar dye or other liquid ejected in droplets which will cure to a solid solution layer upon the lens exterior surface and which will has material therein which will change shape to darken and/or otherwise darken upon UV exposure and which is ejected in droplets by a printer head such as an inkjet printer head. Subsequent to the ink or liquid forming the droplets so applied for a photochromic coating or layer, there may also be included an anti-reflective coating or layer to increase light transmission and a scratch-resistant hard coat to protect the active molecules within the photochromic layer.

With respect to the above description, before explaining at least one preferred embodiment of the method and system herein for inkjet positioning of colorization and imagery and indicia upon lenses in detail, it is to be understood that the invention is not limited in its application to the details of construction and to the arrangement of the components in the following description or illustrated in the drawings. The method for inkjet positioning of one or more layers upon eyewear lenses, as described and shown herein, is capable of other embodiments and of being practiced and carried out in various ways, which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for imparting of colorized layers and indicia and imagery to eyewear lenses and for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. By “optically correct,” is meant that there is little to no visual distortion to the lens or layer of material thereon when viewed through it, and the resulting eyewear lens substantially meets all industry and/or government standards for such an eyewear lens. Where used herein, if not otherwise defined, the term “substantially” means plus or minus five percent.

It is an object of the present invention to provide a system and method for the positioning of colorized layers upon lenses for eyewear using an ink composition yielding substantially transparent inks which are employable using inkjet type print heads or nozzles.

It is another object of the invention herein to provide an ink composition that forms such colorized layers on lenses that, using computer control of the nozzles, can also include imparting images, text, and other indicia to the lens.

It is yet another object of this invention to provide a system which employs an optically correct transparent primer layer to ensure that overlain colorized layers formed of an ink composition maintain strong adhesion to which sequentially applied films and coatings will also adhere.

It is a further object of this invention to ensure that a wearer of the lenses is provided an optically correct viewing area within any imaging printed thereon, with, for example, no dots or uneven printing or visual interference in the viewing area.

It is yet another object of this invention to form photochromic lenses which have the photochromic material deposited in a layer on the exterior surface of the eyewear lens thereby significantly speeding the process and allowing for a high degree of customization of the formed photochromic lenses.

It is another object of this invention to form a photochromic lens which has a gradient pattern of lighter and darker areas using sprayed droplets of Photochromic material in controlled spray patterns.

These and other objects, features, and advantages of the present inkjet colorization and imaging system for eyewear lenses, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed inkjet lens colorization and imagery system herein. It is intended that the embodiments and figures disclosed herein are to be considered illustrative of the invention herein, rather than limiting in any fashion.

In the drawings:

FIG. 1 is a depiction of an inkjet printhead having one or a plurality of inkjet nozzles that deposit the ink composition herein for a colorized layer and/or primer material layer upon a lens substrate.

FIG. 2 depicts one mode of sequentially forming an eyewear lens with multiple optical layers thereon using the system herein.

FIG. 3 shows another mode of sequentially forming an eyewear lens with multiple optical layers thereon using the system herein.

FIG. 4 depicts another mode of sequentially forming an eyewear lens with multiple optical layers thereon using the system herein.

FIG. 5 shows another mode of sequentially forming an eyewear lens with multiple optical layers thereon using the system herein.

FIG. 6 shows a further mode of sequentially forming an eyewear lens with multiple optical layers thereon using the system herein.

FIG. 7 depicts an additional mode of sequentially forming an eyewear lens with multiple optical layers thereon using the system herein.

FIG. 8 depicts the preferred positioning of a viewing area upon each lens and the surrounding multicolor areas where image printing may occur in multiple colors and images.

FIG. 9 shows examples of the colorizing layers the inkjet system herein provides, wherein virtually any color combination or image or text or other indicia may be imparted to the lenses using the formulated ink composition.

FIG. 10 illustrates an embodiment associated with inkjet deposition of photochromic material employing a positioning system to move the lens holder or print head and nozzles, and a controller that controls droplets from the nozzle array.

FIG. 11 illustrates an embodiment associated with inkjet deposition of photochromic material employing one or more nozzles, which are controlled for material or ink deposition along with the lens support movable by the positioning system.

FIG. 12 shows the deposit of the photochromic material positioned in predetermined photochromic regions on the lens substrate in a gradient pattern by control of the ink ejection from the print head and movement of the holder and substrate thereon.

FIG. 13 shows the deposit of the photochromic material in redetermined photochromic regions on the lens substrate zones by control of the ink material ejection from the print head and movement of the holder and substrate thereon.

FIG. 14 illustrates an embodiment associated with droplet deposit from nozzles of an inkjet head controlled by a computer and the controller, where the print head moves along a curved path to accommodate a curved surface of a substrate to maintain an even thickness and pattern.

### DETAILED DESCRIPTION OF THE INVENTION

In this description, the directional prepositions of up, upwardly, down, downwardly, front, back, top, upper, bottom, lower, left, right and other such terms refer to the positions of layers or components as they may be oriented and appear in the drawings and are used for convenience only and such are not intended to be limiting or to imply that the lenses or colorized layers have to be used or positioned in any particular orientation.

Now referring to drawings in FIGS. 1-14, wherein similar components are identified by like reference numerals, there is seen in FIG. 1 a depiction of the system 10 herein wherein an inkjet type printhead 12, which is operatively engaged to a computing device directing movement of a mount holding the printhead 12. The printhead 12 may have one or a plurality of inkjet nozzles 14 or a nozzle array, which deposit liquid droplets of material 16, such as ink, primer material, photochromic material, hard coatings, anti-reflective material, or other layer-forming material from the nozzles 14 and upon a substrate 20 which herein primarily means an eyewear lens such as eyeglasses, or goggles, or other lenses positioned in front of the eyes of a user.

In a preferred mode of the system 10 herein for the formation of colorized regions, the primer material 18 is deposited upon the substrate 20 as a first layer where liquid 16, such as ink, is to be formed on an immediately adjacent layer. The primer material 18, forming the primer layer on the substrate 20, as noted above, may be deposited on the substrate 20 using the nozzles 14 or nozzle array and printhead 12, or by dip coating the lens, or by flow coating the primer material on the substrate 20, such as an eyeglass lens. Alternatively, the goggle lens, eyeglass lenses or substrate 20 may have such a primer layer 18 included thereon in manufacture when needed.

It is the deposit of the primer material 18 and the use of the sprayed droplets of liquid material 16, such as an ink composition noted herein, which may be positioned in a colorized layer using the nozzles 14 of the nozzle array to provide the ability to form an infinite number of colors, color combinations, and indicia, and the like.

Movement of the printhead 12 is controlled by a computer device such as a positioning system 23 controlled by software thereon running to the task of moving the printhead 12, moving the support 22 for the lens or substrate 20, or moving both singularly or concurrently. A controller 21 operates to control droplet deposit from the inkjet nozzles 12 and printing head 12. The positioning system 23 may control movement of the support 22, which may move linearly or may rotate or may do both concurrently as needed to form the desired material layer or pattern on the substrate 20, such as an eyewear lens. The controlled movement of the printhead 12 and support 22 operate in a fashion to form predetermined photochromic regions to yield the pattern, layer, image, or color or the like upon the substrate 20 material forming the eyewear lens, such as a polymeric material or glass.

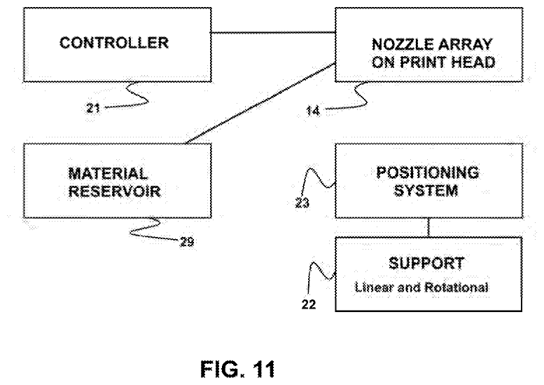

For example, in the case of the colorized layer formed by the ink 17 composition, herein noted, the controlled movement of the printhead 12 and/or support 22 will cause the liquid material 16, in the form of the ink 17 composition, to form a substantially even, uninterrupted colorized ink 17 layer from the cured ink formulation material. Also, by non-limiting example, where an image or colorized or multicolor layer is formed by the emitted liquid material 16, such as in the form of the ink 17 composition (FIG. 11), one or both of the printhead 12 and support 22 can have computer-controlled movements thereof to yield the desired image, indicia, or colorized layer. Such images or indicia or colorization can be from digital images or the like, through which a computer controlling movements of the printhead 12 and/or support 22 will produce.

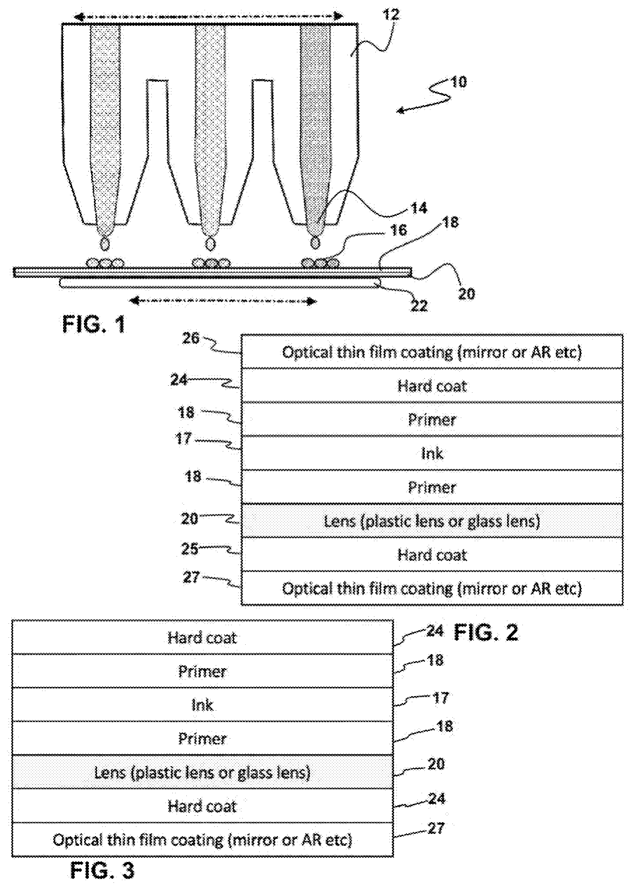

The system 10, employing software running on a computing device operating to the various tasks herein noted, can form eyewear lenses from the substrates 20, which have differing layers of material positioned sequentially thereon. Shown in FIG. 2 is one such mode of sequentially forming an eyewear lens with multiple optical layers thereon using the system 10 herein. As shown, the primer 18 material layer is engaged to the exterior side of the substrate 20 on the side opposite the eyes of the wearer. Upon the cured primer 18 layer is then positioned the ink 17 composition to form a colorized layer using the controlled movements by one or both of the printhead 12 and the support 22 for the substrate 20.

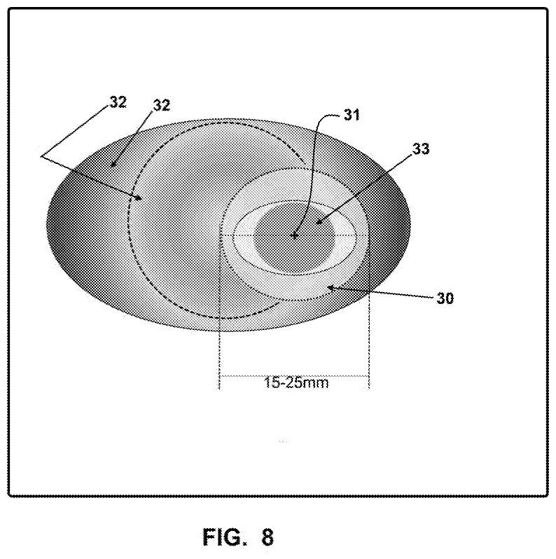

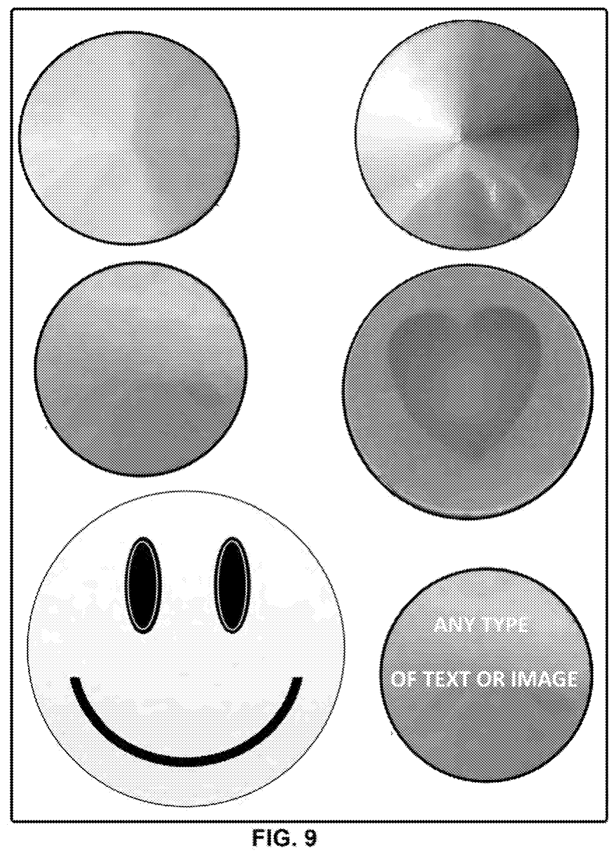

Subsequent to the positioning of the ink 17 composition, layers forming the color or image or indicia or the like, as in FIGS. 8-9, for example, another layer of primer 18 is positioned upon the ink 17 layer. This second layer of primer 18 provides a surface adapted to securely engage and hold an exterior hard coating layer 24. With this exterior hard coating, a 24-layer securely adhered to the primer 18 engaged to the ink 17 layer, an exterior film layer 26 can be securely engaged without fear of the ink 17 layer dismounting.

On the interior side of the substrate 20 is positioned an interior hard coating 25 and an interior film layer 27, which may be a mirror or anti-reflective coating similar to the exterior film layer 26. As noted herein, while denoted as an exterior or interior film coating 26 and 27, it is anticipated, with the employment of the primer 18 layers herein, where such is needed, that these coatings can be formed by liquid material 16 adapted to such and emitted from the nozzles 14, or the coatings can be formed by immersion or other conventional means.

Another mode of the formation of the eyewear lens from the substrate 20 is shown in FIG. 3. As shown, a primer 18 layer is formed on the exterior side of the substrate 20 either using the liquid material 16 configured to form such a primer layer 18 emitted from the nozzles 14, or by forming such a primer layer 18 on the substrate 20 using an immersion coating, a flow coat, or the like. Thereafter, the ink 17 composition forming the colorized layer is adhering to the primer 18 layer by the nozzles 14 emitting liquid material 16 in the form of the ink 17, in the composition noted, to form the colorized layer, image, indicia, or the like from the ink 17.

Because the ink 17 formulation herein cures the colorized layer, which will not peel easily, another or second primer 18 layer can be positioned on the cured colorized layer formed by the ink 17 composition, noted herein. This can be done using liquid material 16 from the printhead 12 configured for such or by employing the noted primer materials herein or their equivalent in a flow coat or immersion process. Thereafter, the exterior hard coating 24 layer is engaged upon the second primer 18 layer. On the interior of the substrate 20, forming the eyewear lens, an interior hard coating 25 is adhered to the substrate 20 and an interior film coating 27.

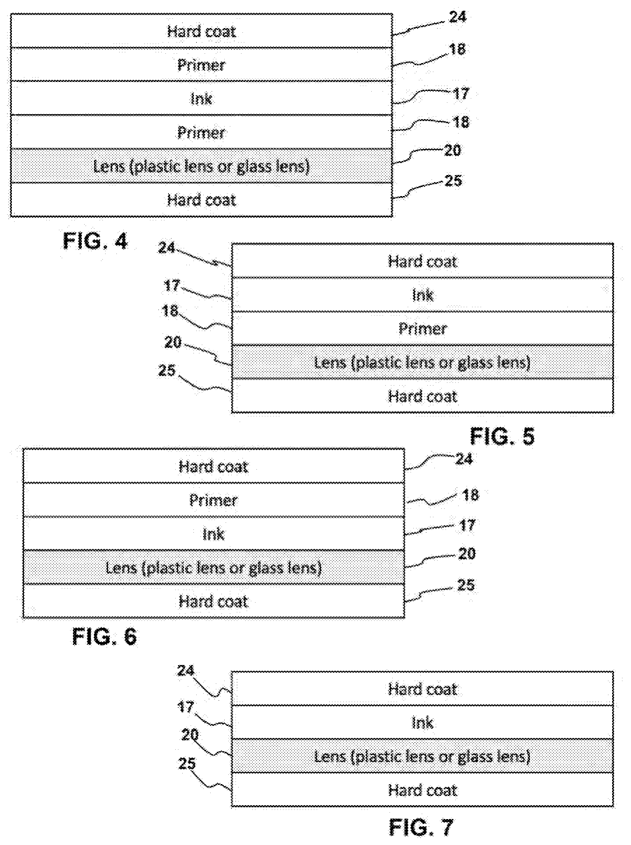

In FIG. 4 is shown another mode of sequentially forming an eyewear lens with multiple optically correct layers thereon using the system 10 herein. As shown, the transparent primer 18 layer is first formed by the noted primer material herein, which is communicated onto the substrate 20 by flow coating, immersion, or where sprayable, by the nozzles 14. Thereafter, liquid material 16, in the form of the above-noted transparent ink 17 composition, is communicated and adhered to the primer 18 layer by the nozzles 14. This allows for the formation of a colorized layer from the ink composition to thereby form colored layers, images, mixtures, rainbows, or indicia or the like for which the eyewear lens the substrate 20 will be used. On the interior side of the substrate 20 forming the lens is an interior hard coating 25.

In FIG. 5 is shown another mode of the sequentially formed eyewear lens using the substrate 20. As shown, the primer 18 layer is formed either by the liquid material 16 from the nozzles 14 adapted to form the optically correct transparent primer 18 layer, or by immersion or flow coating, or the like. Thereafter, the colorized layer formed of the ink 17 composition is applied using the liquid material 16 in the form of the ink 17 composition from the nozzles 14 of the printhead 12. Using the computer-controlled nozzle and/or platform movement and positioning, the colorized layer of an image, multiple colors, indicia, or the like can be easily positioned in a highly customizable fashion. Because the colorized layer formed by the ink 17 composition is securely engaged to the substrate 20 by the adherence thereof to the primer 18, the exterior hard coating 24 can be applied directly onto the colorized layer formed by the ink 17 composition, noted herein, without fear of a dismount. An interior hard coating 25 is shown engaged upon the interior surface of the substrate 20 forming the lens.

Shown in FIG. 6 is a further mode of sequentially forming an eyewear lens from the substrate 20 with multiple layers thereon using the system herein. As can be seen, the liquid material 16 from the nozzles 14 in the form of the transparent ink 17 composition herein, is applied to the exterior of the substrate 20. In this case, the ink 17 composition may have the transparent primer material included in the formulation of the ink 17 composition, or the composition mixture itself may be adjusted to aid in the secure adherence to the substrate 20 eyeglass lens.

Adhered upon the colorized layer formed by the sprayed ink 17 composition herein, which, as noted, forms an infinite number of colors and/or images and/or indicia on the substrate 20 herein, such as in FIGS. 8-9, is a primer 18 layer to which the exterior hard coating 24 layer is engaged securely. An interior hard coating 25 is engaged directly to the substrate 20, forming the lens on the side facing the eyes of the wearer.

In FIG. 7 is shown an additional example of a mode of sequentially forming an eyewear lens from the substrate 20 with multiple optically correct layers thereon using the system herein. As shown, material 16 emitted from the nozzles 14 in the form of the transparent ink 17 composition will form a colorized layer of one or multiple colors and/or imagery and/or indicia, such as shown in FIGS. 8-9. This colorized layer is adhered to the lens substrate 20 on the exterior side thereof. The formed colorized layer from the nozzle-applied ink 17 composition, so deposited, may be adjusted in the mixture of the above noted composition or may include a portion of primer or some version thereof, to enhance the engagement of the colorized layer formed by the ink 17 composition. To the colorized layer, formed by the nozzle-deposited ink 17 composition, is added the exterior hard coating 24. On the interior surface of the substrate 20 is adhered the interior hard coating 25 layer.

In FIG. 8 is shown the preferred positioning of a viewing area 30 upon a substrate 20, such as an eyewear lens. The viewing area 30, as noted above, will surround a center point 31 determined to substantially align with a pupil of the eye 33 of the wearer. This viewing area 30 is preferably at least 15 mm in diameter horizontally to either side of the center point 31, and a current preferred range is 15mm-25 mm, with 20 mm being a current favorite as experimentation has shown such to provide optically correct viewing in a perceived single color for the lens wearer. Outside the viewing area 30 is a multicolor area wherein any imaging, colorization, or multicolor coatings and the like may be placed without interfering with the clear viewing by the user through the viewing area 30.

As noted, multiple layers of coatings and the like may be placed within the viewing area 30 so long as a single evenly disbursed color or no color is placed within the viewing area 30. As noted, layers of hard coat 24 or primer 18 or ink 17 may be placed within the viewing area 30 so long as they produce an even or single color therein which has no lines or dots or overlays and the like which would interfere with vision of the wearer therethrough. Where digital images or artwork are used to produce the images or colors or the like on the substrate 20, such as an eyeglass lens, it will be adjusted, if necessary, to allow only a single color of ink 17 therein. Any other layers of hardcoat 24 or primer 18 or ink 17 will also have an even single color whereby the view through the viewing area 30 for the user will appear as a conventional lens or sunglass lens with an even single color perception to the wearer.

In FIG. 9 is shown some non-limiting examples of the substantially infinite colorization, indicia, and imagery which the system herein provides during the formation of eyewear lenses from lens substrate 20 material. As noted, using the inkjet type printer or printer head 12, and/or computer-controlled movement spray nozzle, liquid material 16 in the form of the ink 17 composition noted is employable to form one or multiple colors in the colorized layer. While not depicted in all of the example substrate lenses in FIG. 9, a viewing area 30 would be included where necessary to provide the user with substantially optically correct viewing through the eyeglass lens or substrate 20.

The employment of inkjet or computer-controlled nozzle printing of such indicia and imagery in a colorized layer formed by the ink composition herein significantly enhances the speed of lens formation with such. Further, because the formed indicia and colors and the like on the substrate 20 is performed by nozzles 14, such as those from a computer-controlled printhead 12, virtually any image or color or color combination can be easily formed on each substrate 20. This enables easy customization of each substrate 20 for the color and design of the eyewear lens to that desired by the buyer, without any slowing of the manufacturing process since all of the lenses are formed in that fashion.

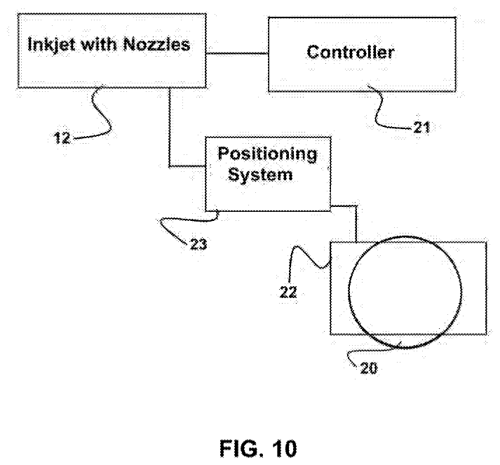

Shown in FIG. 10 is an illustration of an embodiment of the system 10, which employs a printhead 12 to deposit liquid material 16 droplets, which are formed of photochromic material. This allows for the formation of a photochromic lens which has the photo-reactive photochromic layer formed on an exterior surface of the lens or substrate 20. As noted, this allows for a high degree of customization of the eyewear, which does not require conventional preformed photochromic lenses where the reactive material is formed into the polymeric material of the lens itself.

The photochromic layer 25 is formed on an exterior surface of the lens substrate 20, employing a positioning system 23 which controls movements of the inkjet print head or the lens support 22. A controller 21 operates to coordinate droplet ejection timing and positioning in predetermined photochromic regions to allow for the desired pattern, thickness, and level of darkening of the formed photochromic layer 25 on a substrate 20. Multiple deposition passes by the printhead 12 or nozzles 14 of the nozzle array thereon are controllable to build material thickness. The controller 21 may regulate material 16 droplet ejection timing, droplet volume, and droplet spacing to achieve a desired photochromic layer 25 thickness. The support 22 may have a rotational stage configured to rotate the lens substrate 20 during droplet deposition thereon, which may be controlled for rotation by the positioning system 23, such as with an electric motor and software operating thereon to that task. The curing system noted above may stabilize deposited liquid material using ultraviolet radiation or thermal energy. Multiple print heads 12 with multiple nozzles 14 may deposit different materials, including adhesion layers or protective coatings, onto the substrate 20 or formed photochromic layer 25.

In the system 10 herein, the photochromic layer 25 is positionable on the substrate 20 after formation and any grinding of the substrate 20 where it is a corrective or prescription lens. The lens support 20 may support any curved lenses, including sunglass lenses, ophthalmic lenses, or clear lenses, and allow for the formation of the photochromic layer 25 on an exterior surface thereof.

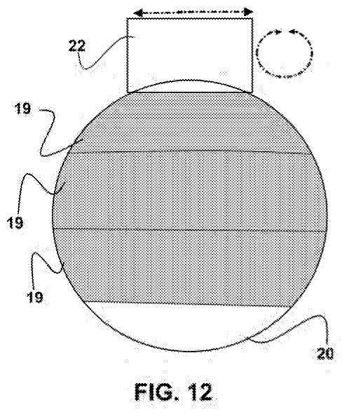

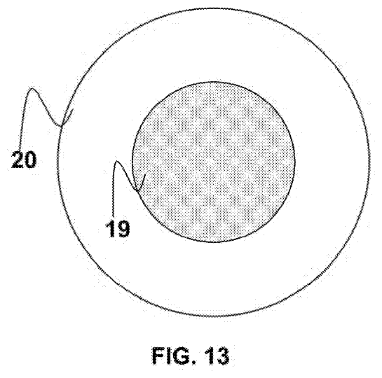

Shown in FIG. 11 is a depiction of an embodiment of the product of the system 10 herein associated with the inkjet nozzle 12 deposition of droplets of material 16, which is formed of photochromic material. As shown, the compute controller 21 controls movement of one or both of the print head 12 or inkjet nozzles 13 or lens support 20, to allow for the formation of the desired photochromic layer 25 on an exterior surface area of the substrate 20, such as an eyeglass lens or goggle lens. By exterior surface is meant upon the substrate 20 itself, or upon a primer or other coating layer positioned on the exterior surface of the substrate 20 where required. As shown, the positioning system 23 may be controlled by software running to the task of controlling movement of one or more of the inkjet nozzles 14 or printer head 12 or support 22 to allow the projected droplets of liquid material 16 such as photochromic material, to form the photochromic layer 25 desired. It may be an evenly distributed photochromic layer 25, or a zone formed layer as in FIG. 13, or may be a gradient pattern as in FIG. 12, or another desired pattern on the exterior of the substrate 20. Selective droplet placement of the material 16 from the inkjet nozzles 14 may form gradient photochromic regions 19, such as in FIG. 12.

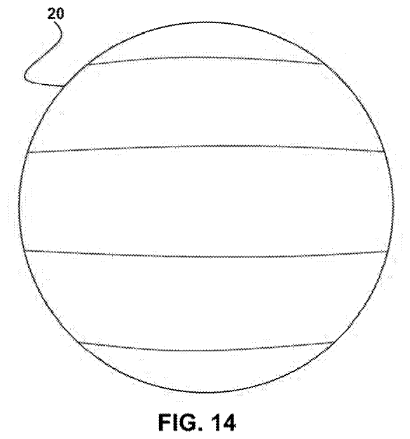

In FIG. 14 is depicted the system 10 controlling the print head 12 or inkjet nozzles 14 to deposit droplets of material 16 in a manner to accommodate the curve of the exterior of the lens or substrate 20. It was found in experimentation that, where there is a curved surface, the printer head 12 must follow an arc pattern around the exterior of the substrate 20 in a curved path rather than a linear path in order to maintain a constant thickness of the photochromic layer 25. Thus, the positioning system 23 may move the print head 12 relative to the lens substrate 20 along paths that correspond to the curvature of the lens surface. In some embodiments, the print head 12 follows a curved deposition path that mirrors the curvature of the substrate 20 or lens in order to maintain a substantially constant stand-off distance between the nozzle 14 array and the curved lens surface of the substrate. Maintaining the constant stand-off distance and curve improves droplet placement accuracy and contributes to forming a uniform photochromic layer 25 across the curved lens surface.

It should be noted that any of the different depicted and described configurations of the inkjet-imparted images and layers for eyewear lenses herein can be employed with any other configuration or component shown and described as part of the device herein. Additionally, while the present invention has been described herein with reference to particular embodiments thereof and/or steps in use, a latitude of modifications, various changes and substitutions are intended in the foregoing disclosure, and it will be appreciated that in some instance some features, or configurations, of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A system for forming a photochromic lens comprising:
an inkjet print head including a nozzle array configured to eject droplets of a photochromic material;
a lens holder configured to support a lens substrate having a curved surface;
a positioning system configured to control relative movement between the inkjet print head and the lens substrate; and
a controller configured to control droplet ejection from the nozzle array to deposit droplets of the photochromic material onto the exterior curved surface of the lens substrate to form a photochromic layer thereon.

2. The system of claim 1, wherein the positioning system includes a rotational stage configured to rotate the lens substrate during droplet deposition.

3. The system of claim 1, wherein the positioning system includes at least one translational stage configured to move the inkjet print head relative to the lens substrate.

4. The system of claim 1, further comprising a material reservoir fluidically coupled to the inkjet print head.

5. The system of claim 1, further comprising a curing system configured to cure deposited photochromic material.

6. The system of claim 1, wherein the controller controls droplet placement to form predetermined photochromic regions on the lens substrate.

7. The system of claim 1, wherein the lens substrate comprises an ophthalmic lens having a pre-formed corrective optical geometry.

8. The system of claim 1, wherein the lens substrate comprises a sunglass lens.

9. A method of forming a photochromic lens comprising supporting a lens substrate having a curved surface, positioning an inkjet print head relative to the lens substrate, and depositing droplets of photochromic material onto the curved surface to form a photochromic layer.

10. The method of claim 9, further comprising rotating the lens substrate relative to the inkjet print head during droplet deposition.

11. The method of claim 9, further comprising translating the inkjet print head relative to the lens substrate during droplet deposition.

12. The method of claim 9, wherein the positioning system moves the inkjet print head along a curved path corresponding to the curvature of the lens substrate.

13. The method of claim 9, wherein the inkjet print head is maintained at a substantially constant stand-off distance from the curved surface of the lens substrate during droplet deposition.

14. The method of claim 9, wherein droplet deposition is controlled to produce a substantially uniform photochromic layer thickness across the curved surface of the lens substrate.

15. The method of claim 9, wherein droplet spacing and droplet volume are controlled to regulate the thickness of the deposited photochromic layer.

16. The method of claim 9, further comprising depositing multiple passes of photochromic material to form a layer having a predetermined thickness.

17. The method of claim 9, wherein droplets are deposited according to a predetermined pattern defining photochromic regions on the lens surface.

18. The method of claim 9, wherein the predetermined pattern produces a gradient photochromic response across the lens surface.

19. The method of claim 9, further comprising adjusting droplet placement coordinates to compensate for the curvature of the lens substrate.

20. The method of claim 6, wherein said predetermined photochromic regions form a gradient pattern.
